(19) United States
(12) Patent Application Publication
(10) Pub. No.: US 2023/0281451 A1
(43) Pub. Date: Sep. 7, 2023

(54) Computer-Implemented Method of Synaptic Consolidation and Experience Replay in a Dual Memory Architecture

(71) Applicant: NavInfo Europe B.V., Eindhoven (NL)

(72) Inventors: Fahad Sarfraz, Eindhoven (NL); Elahe Arani, Eindhoven (NL); Bahram Zonooz, Eindhoven (NL)

(21) Appl. No.: 17/686,263

(22) Filed: Mar. 3, 2022

(51) Int. Cl. G06N 3/08; G06F 17/16

(52) U.S. Cl. CPC G06N 3/082; G06F 17/16

(57) ABSTRACT

A computer-implemented method of synaptic consolidation for training a neural network using an episodic memory, and a semantic memory, by using a Fisher information matrix for estimating the importance of each synapse in the network to previous tasks of the neural network; evaluating the Fisher information matrix on the episodic memory using the semantic memory; adjusting the importance estimate such that functional integrity of the filters in the convolutional layers is maintained whereby the importance of each filter is given by the mean importance of its parameters; using the weights of the semantic memory as the anchor parameters for constraining an update of the synapses of the network based on the adjusted importance estimate; updating the semantic memory and fisher information matrix stochastically using exponential moving average, and interleaving samples from a current task with samples from the episodic memory for performing the training.

### BACKGROUND OF THE INVENTION

### Field of the Invention

Embodiments of the present invention relate to a computer-implemented method of synaptic consolidation for training a neural network using experience replay in a dual memory architecture.

### Background Art

A major challenge towards achieving general intelligence and making deep neural networks (DNNs) suitable for deployment in an ever-changing environment is the ability to continuously acquire and consolidate knowledge. DNNs exhibit catastrophic forgetting whereby the network's performance on previously learned tasks drops drastically as they learn a new task. In the brain, efficient lifelong learning is mediated by a rich set of neurophysiological mechanisms and multiple memory systems. Catastrophic forgetting in DNNs can be majorly attributed to the violation of the strong Independent and identically distributed assumption, underpinning the success of standard DNNs training, in the sequential learning of tasks involved in continual learning. Furthermore, catastrophic forgetting is also considered as an inevitable consequence of connectionist models as all the weights of the network are updated to learn a task, overwriting the important weights for the previous tasks. In addition to addressing the above-mentioned challenges, an efficient Continual learning (CL) method needs to maintain a delicate balance between the plasticity and stability of the model. The model should have enough plasticity to adapt to the new data while being stable enough to not forget the previously acquired knowledge.

Several approaches have been proposed to address the issue of catastrophic forgetting in CL. These can be broadly categorized into three categories.

Regularization-based methods^{[1, 2, 3, 4]} draw inspiration from synaptic consolidation in brain to propose algorithms which controls the rate of learning on model weights based on how important they are to previously seen tasks. Elastic Weight Consolidation (EWC)^{[2]} slows down learning on a subset of network weights which are identified as important for previous tasks, thereby anchoring these parameters to previously found solutions by constraining the identified important parameters to remain close to the optimal parameters for previous tasks. EWC tries to keep the network parameters close to the learned parameters of all the previous tasks by maintaining the learned parameters and corresponding Fisher information matrices for each task to enforce separate penalty terms for each. This however, over-constrains the network updates and makes the computational and memory cost linear in the number of tasks. Online EWC^{[18]} and EWC++^{[19]} relaxes this constraint by applying Laplace approximation to the whole posterior whereby the Gaussian approximation of previous task likelihoods are “re-centered” at the latest MAP parameter and a running sum of the Fishers. While regularization approaches constitute a promising direction, they alone fail to enable effective continual learning in DNNs and fail to avoid catastrophic forgetting in more challenging CL settings e.g. Class Incremental learning (Class-IL) whereby in each task a new set of disjoint classes are added. Additionally they require task boundary and/or task label information which limits their application in the more realistic general incremental learning setting (GIL) where task boundaries are not discrete

Network expansion-based methods^{[5, 6]} dedicate a distinct set of network parameters to distinct tasks. However, they fail to scale to longer sequences as the network grows linearly with the number of tasks.

Rehearsal-based approaches^{[7, 8, 9, 10, 11, 12, 13, 14]} on the other hand, are inspired by the critical role that the replay of past neural activation patterns in the brain plays in memory formation, consolidation, and retrieval. Experience Replay^{[10]} typically involves storing a subset of samples from previous tasks and mixing them with data from the new task to update the model parameters with an approximate joint distribution and have proven to be effective in reducing catastrophic forgetting under challenging CL setting^{[15]}. Several techniques have since been employed on top of ER to efficiently utilize the memory samples. In particular, Dark Experience Replay (DER++)^{[14]} samples logits during the entire optimization trajectory and adds the consistency loss to regularize the model update. A limitation of experience replay methods is that the memories being stored and replayed needs to be proportional to the number of tasks as for a fixed buffer size, the representation of earlier tasks in memory diminishes as we learn over longer sequences. Furthermore, an optimal mechanism for replay is still an open question^{[20]}.

Complementary Learning Systems theory has further inspired dual memory learning systems. Nitin Kamra et al.^{[23]} Utilizes two generative models. So called CLS-ER^{[22]}, also known as complementary learning systems with experience replay, mimic the rapid and slow learning in CLS by maintaining long-term and short-term semantic memories which aggregates the weights of the model at different rates and interact with the episodic memory for efficient replay. These works demonstrate the effectiveness of multiple memory systems.

While all these approaches have their merits and demerits and individually constitute a viable direction for enabling efficient continual learning in DNNs, research has been predominantly orthogonal.

Accordingly, there is a need to enable efficient continual learning using both experience replay in a dual memory system and synaptic consolidation in a manner that does not utilize the task boundaries and is suitable for general continual learning. The present invention aims to satisfy this need.

### BRIEF SUMMARY OF THE INVENTION

Embodiments of the present invention employ synaptic consolidation, experience replay and multiple memory systems in a single system in order to improve on the prior art.

According to a first aspect of the invention, a computer-implemented method of synaptic consolidation for training a neural network, also known as a working model, uses an episodic memory, and a semantic memory. An episodic memory is preferably an instance-based memory buffer of previous tasks that is updated with current tasks at the expense of samples of previous tasks. The semantic memory is an exponential weighted averaged model of working model's weights. The method comprises the step of using a Fisher information matrix for estimating the importance of each synapse in the network to previous tasks of the neural network. For reference information, it is provided that in mathematical statistics, the Fisher information is a way of measuring the amount of information that an observable random variable X carries about an unknown parameter θ of a distribution that models X. The Fisher information matrix is used to calculate the covariance matrices associated with maximum-likelihood estimates. The method further comprises the step of evaluating, that is to say, finding an expression for, the Fisher information matrix using the semantic memory on the samples in the episodic memory and aggregated the fisher information matrices stochastically throughout the training trajectory. In this manner the importance of a synapse is checked against all of the previously encountered tasks instead of just against a current task, which may bias the importance parameters to the current task. The method adjusts the importance estimate such that functional integrity of the filters in the convolutional layers is maintained whereby the importance of each filter is given by the mean importance of its parameters. The method further comprises constraining the update of the working model by penalizing changes in the weights of the important parameters given by the adjusted fisher information matrix from the parameter values in the semantic memory, thereby acting as an anchor for the network update in order to reinforce learned tasks the method further comprises interleaving samples from a current task with samples from the episodic memory for performing the training. In this way, it produces a concatenated current task and memory batch for the training.

Further to the above, the semantic memory can be considered to interact with the episodic memory so as to enforce consistency regularization on each model update whereby the model is encouraged to match the output logits of the semantic memory.

Furthermore, to employ synaptic consolidation, the method preferably estimates the importance of each filter using adjusted Fisher information matrix which takes into account the functional integrity of the filter unit and anchors the parameters of the method to the semantic memory. Preferably, also separate from the above, in some embodiments the method does not utilize any task boundaries. In this way, embodiments of the present invention constitute an efficient general incremental learning that efficiently employ synaptic consolidation and a dual memory-based replay mechanism that achieves high end performance across challenging CL scenarios. In other words, the method can exclude the use of task boundaries and instead updates the Fisher information matrix stochastically to improve performance.

Optionally, the learned weights of the synapses of the network are updated to an overall loss function. The loss function in method quantifies the difference between the expected outcome and the outcome produced by the working model, in other words the neural network. The overall loss function for updating the working model comprises of three components, namely: i) a standard cross-entropy loss, LCE, on the concatenated task and memory batch, ii) a consistency loss between logits of the working model and the sematic memory on the samples of previous tasks; and iii) a synaptic consolidation. The overall loss used to update the working model is then given by the weighted sum of individual losses i), ii) and iii).

Optionally, the step of evaluating the Fisher information matrix comprises using an exponential moving average to aggregate the Fisher matrix throughout the training.

Optionally, to maintain the structural functionality of filters in the convolutional layers, the method adjusts the importance estimate such that the importance is defined at a filter level instead of its individual parameters. Method uses use the mean of the channel parameters in the aggregated fisher information matrix to estimate the importance of a filter.

### DETAILED DESCRIPTION OF THE INVENTION

Similar to the brain, embodiments of the present invention aim to incorporate synaptic consolidation and experience replay in a dual memory general continual learning method. The key premises is that these mechanisms are complementary and can together overcome the shortcomings of each approach alone to enable effective and efficient continual learning in artificial neural networks (ANNs). The main components of the method are as follows:

Multiple Memories.

Replay of past neural activation patterns in the brain is considered to play a critical role in memory formation, consolidation and retrieval^{[24,25]} CLS-theory further provides a framework to explain how replay is effectively used to incorporate new experiences encoded by a rapid instance based system (Hippocampus) to structured knowledge representation in a slow parametric system (Neocortex) to concurrently learn efficient representations for generalization and the specifics of instance-based episodic memories. Inspired by these studies, methods of the present invention employ an instance based memory system and a semantic memory which maintains consolidated structured knowledge across the learned tasks.

1. Episodic Memory:

To replay samples from the previous tasks, an episodic memory buffer is utilized, M with fixed budget B, as an instance based memory system which can be thought of as a very primitive hippocampus, permitting a form of complementary learning^{[26]}. As the present example focusses on general incremental learning (GIL), reservoir sampling^{[27]} is employed to maintain the memory buffer, which explicitly does not utilize the task boundaries to select the memory samples. Instead the method attempts to approximately match the distribution of the incoming stream by assigning equal probability to each sample for being added to the buffer by replacing a random sample in the buffer. While reservoir sampling is simple, effective and suitable for general incremental learning, any other method for memory selection and retrieval can alternatively also be employed in the method.

2. Semantic Memory:

The acquired knowledge of the tasks in DNNs is represented in the learned weights^{[2,28]}. Therefore, it is an aim to progressively accumulate and consolidate knowledge across the tasks encoded in the subsequently learned weights of the working model, Ow throughout the training trajectory. To this end, one can maintain the semantic memory by taking the exponential moving average of the working model as it provides an efficient approach for aggregating weights.

θ_{S}=α_{S}+(1−α)θ_{W}, if r_{S}>U(0,1) Equation 1: Eq 1 in Algorithm 1

where α is the decay parameter and rₛ is the update probability. As the semantic memory is designed to stochastically accumulate knowledge across the entire training trajectory by aggregating the weights of the working model, it can also be considered as an ensemble of several student models with varying degrees of specialization for different tasks. The semantic memory here loosely mimics the Neocortex as it constitutes a parametric memory system for generalization that interacts with the instance level episodic memory to efficiently accumulate and consolidate knowledge.

Synaptic Consolidation

In the brain, synaptic consolidation supports continual learning by reducing the plasticity of synapses that are considered important to previously learned tasks. This is enabled by complex molecular machinery in biological synapses that allows multiple scales of learning by mediating the plasticity of individual synapses^{[21, 29]}. In ANNs, on the other hand, synapses are only described by a scalar value, and employing synaptic consolidation requires an additional estimate of the importance of each synapse to the previous tasks. To this end, one can utilize the Fisher information matrix to estimate the importance of each parameter. In this example one can maintain a running approximation of the Fisher information matrix but make several modifications to make the algorithm suitable for GIL and enable efficient consolidation of information across the tasks. Concretely, our method does not utilize the task boundaries and instead updates the fisher information matrix stochastically using an updated probability. Furthermore, in order to avoid the parameter importance update from being biased towards the current task, instead of using the training data of the current task, one can use the samples in the memory buffer to calculate the Fisher information matrix. Since reservoir samples attempt to approximate the joint distribution of incoming stream, this provides a better estimate of parameter importance for all the tasks seen so far and therefore more optimal constraints for the model update. Additionally, it is noted that one shortcoming of the regularization-based approaches is that they do not consider the structural functionality of filters in the convolutions neural networks. Each filter consists of a unit that extracts a specific feature from the input, therefore allowing large changes in some parameters of the filter while penalizing changes in others fail to prevent drift in the functionality of the filter unit which might be important for the previous tasks. For instance, a horizontal edge detector requires each parameter of the filter to have certain values and changes in even a few parameters change the functionality of the filter. To address this shortcoming, we modify the fisher information matrix such that a uniform penalty is applied to each parameter of a filter. Specifically, for applying the penalty term, for each filter in the convolutional layer, we calculate the mean importance value and assign it to each parameter of the filter in the adjusted fisher information matrix, Fadj.

Formulation: SYNERgy employs a dual memory experience replay mechanism in conjunction with synaptic consolidation. It involves maintaining multiple memory systems: A fixed episodic memory M with budget size B which is maintained through reservoir sampling and an additional semantic memory θs which aggregates the weights of the working model Ow by taking an exponential moving average of its weights using Equation 4. While training, samples from the current task, (Xₜ, Yₜ)˜Dₜ, are interleaved with a random batch from the memory buffer, (Xₘ, Yₘ)˜M. The overall loss function for updating the working model comprises of three components:
1) Supervised Loss: consists of the standard cross-entropy loss, LCE, on the concatenated task and memory batch, (X, Y)←Concat(Xt, Xm), Concat(Yt, Ym). This ensures that the model learns from the approximate joint distribution of all the tasks seen so far.
2) Consistency Regularization: To replay the neural activation patterns that accompanied the learning event, we utilize the semantic memory to extract the consolidated logits for efficient replay of the memory samples. As the semantic memory aggregates information across the tasks, it takes into account the required adaptations in the decision boundary and the feature space to provide consolidated logits for replay which facilitates consolidation of knowledge. Concretely, we apply a consistency loss between the logits of the working model and the sematic memory on the memory samples.

[symbol]

_{CR}= [symbol] _{MSE}(f(Xₘ;θ_{W}),f(Xₘ;θ_{S})) Equation 2

Where LMSE is the mean squared error.
3) Synaptic Consolidation: To incorporate synaptic consolidation in our method, we utilize the Empirical Fisher Information Matrix F to estimate the importance of each parameter for the previous task. We apply Laplace approximation to the entire posterior and replace the mean with the latest MAP parameters and aggregated Fisher information matrix. We make several modifications to the approach to improve the parameter importance estimate and make the method suitable for general incremental learning as the current approaches utilize the task boundaries which limits their application in the GIL setting. Notably, at task t, we use the memory buffer M to approximate the expectation over the joint distribution of tasks seen so far (D1 ∪ . . . ∪ Dt) which gives a better estimate of parameter importance for all the tasks instead of the usual approach of calculating F on the current task's training data which can bias the parameter's importance estimate to the current task. Furthermore, we use the semantic memory, θs, to evaluate F and consequently as an anchor for constraining the network update as it effectively consolidates information across the tasks, and can therefore provide a better estimate of optimal MAP parameters for the tasks.

$$Eq 3 in Algorithm 1 \\ {{θ}_{s}}_{} = {𝔼}_{( x , y ) \sim ℳ} [ ( \frac{\partial log {p}_{{θ}_{s}} ( y \vert x )}{\partial {θ}_{S}} ) {( \frac{\partial log {p}_{{θ}_{s}} ( y \vert x )}{\partial {θ}_{S}} )}^{T} ] \qquad Equation 3$$

Since our focus is on GIL, we want to avoid utilizing the task boundaries to calculate F and save the model's state as anchor parameters. Instead, we take a stochastic approach to evaluate the Fisher information matrix and use an exponential moving average to aggregate F throughout the training trajectory instead of only at the task boundaries.

[symbol]

=α_{F} [symbol] +(1−α_{F}) [symbol] ₜ, if r_{F}>U(0,1) Equation 4: Eq 4 in Algorithm 1

Where α_{F} is the decay parameter which controls the strength of update and r_{F} is the rate of update.

Furthermore, to maintain the structural functionality of filters in CNNs, we adjust the importance estimate such that importance is defined at a filter level instead of its individual parameters. We use the mean of the channel parameters in the aggregated fisher information matrix to estimate the importance of a filter. The synaptic consolidation loss is then given by the quadratic penalty weighted by the adjusted fisher information matrix.

[symbol]

_{sc}= [symbol] Equation 5

Overall Loss: The overall loss used to update the working model θ_{W} is then given by the weighted sum of individual losses.

[symbol]

= [symbol] _{ce}+λ_{CR} [symbol] _{CR}+λ_{sc} [symbol] _{sc} Equation 6

Where λ_{CR} and λ_{SC} controls the strength of consistency loss and synaptic consolidation respectively. Further details of the method are given in Algorithm 1. Note that for inference we use the semantic memory as it learns consolidated features that can generalize across the tasks.

Algorithm 1 Synaptic Consolidation with Experience Replay
Input: Data stream [symbol] , Learning rate η, regularization strengths λ_{CR} and λ_{SC}, Update rates r_{S} and r_{F},
Decay parameters α_{S} and α_{F}
Initialize: θ_{S}=θ_{W}
[symbol] ←{ }
1: while Training do
2: (X_{b}, Y_{b})˜ [symbol]
3: (Xₘ, Yₘ)˜ [symbol]
4: (X, Y)={(X_{b}, Y_{b}), (Xₘ, Yₘ)}
5: Z_{S}←f(Xₘ; θ_{S})
6: Adjust Fisher Information Matrix, [symbol] _{adj}
7: [symbol] = [symbol] _{CE} (σ(f(X; θ_{W})),Y)+λ_{CR} [symbol] _{MSE}(f(Xₘ; θ_{W}), Z)+λ_{SC} [symbol]
8: θ_{W}←θ_{W}−η∇_{θ}_{_{W}} [symbol]
9: a, b˜ [symbol] (0,1)
10: Update Semantic Model, θ_{S}, with Eq 1 if a<r_{S}
11: Evaluate Fisher Information Matrix [symbol] with Eq 3 and update the aggregated Fisher Information Matrix [symbol] with Eq. 4 if b<r_{F}
12: [symbol] ←Reservoir( [symbol] , (X_{b}, Y_{b}))
return θ_{W}, θ_{S}

Algorithm 1 describes:

A computer-implemented method of synaptic consolidation during the training of a neural network using an episodic memory, and a semantic memory, wherein said method comprises the step of:
Line 2) obtaining a data stream [symbol] comprising neural network input (X_{b}) and corresponding label (Y_{b});
Line 3 and 4) form a concatenated set of task samples (X, Y) using samples of the data stream (X_{b}, Y_{b}) with previous samples from the episodic memory (Xₘ, Yₘ)
Line 5) extracting the replay logits Z_{S} for the previous samples Xₘ from the episodic memory [symbol] using the semantic memory θ_{S}, wherein the semantic memory is the exponential moving average of the weights of the neural network θ_{W},
Line 6) adjusting a Fisher Information Matrix, which comprises estimating the importance of each synapse in the network using a Fisher information matrix in the first place, wherein the Fisher information matrix is evaluated using the semantic memory, and wherein the Fisher information matrix is a aggregated over time using an exponential moving average;
Line 7) determining an overall loss function;
Line 8) updating the weights of the synapses of the neural network using the overall loss function. Further lines are optional
Line 9) generate values a and b, such as at random, each between 0 and 1;
Line 10) Update the semantic memory, θ_{S}, with Eq 1 if a a<r_{S};
Line 11) Update the Fisher Information Matrix, [symbol] , with Eq 2 if b<r_{F}
Line 12) Add the input sample (X_{b}) and corresponding label (Y_{b}) from the data stream to the episodic memory [symbol] , and remove an equal amount of older samples from the episodic memory [symbol] at random.

Embodiments of the present invention can include every combination of features that are disclosed herein independently from each other. Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Terms:

Importance may be understood as relative importance between synapses and/or parameters of filters, wherein importance is defined as a value, wherein more important synapse and/or parameters have a higher value than less important synapse or parameters with respect to each other. Parameters above a predefined threshold value may be considered important, while those at or below said threshold value may be considered unimportant.

Parameters of filters may comprise network weights.

To anchor may be understood as using elastic weight consolidation to slow down learning on a subset of weights, which are identified as being important or by slowing down learning on all weights proportional to, or as a function of, their relative importance.

Supervised task loss, also just supervised loss, may be seen as a standard cross-entropy loss, such as resulting from interleaving.

A logit is a quantile function associated with standard logistic distribution based on probability, such as of a sample.

### REFERENCES

[1] Mehrdad Farajtabar, Navid Azizan, Alex Mott, and Ang Li. Orthogonal gradient descent for continual learning. In International Conference on Artificial Intelligence and Statistics, pages 3762-3773. PMLR, 2020
[2] James Kirkpatrick, Razvan Pascanu, Neil Rabinowitz, JoelVeness, Guillaume Desjardins, Andrei A Rusu, KieranMilan, John Quan, Tiago Ramalho, Agnieszka Grabska-Barwinska, et al. Overcoming catastrophic forgetting in neural networks. Proceedings of the national academy of sciences, 114(13):3521-3526, 2017
[3] Hippolyt Ritter, Aleksandar Botev, and David Barber. On-line structured laplace approximations for overcoming catastrophic forgetting. In Advances in Neural Information Processing Systems, pages 3738-3748, 2018
[4] Friedemann Zenke, Ben Poole, and Surya Ganguli. Continual learning through synaptic intelligence. Proceedings of machine learning research, 70:3987, 2017
[5] Andrei A Rusu, Neil C Rabinowitz, Guillaume Desjardins, Hubert Soyer, James Kirkpatrick, Koray Kavukcuoglu, Raz-van Pascanu, and Raia Hadsell. Progressive neural networks. arXiv preprint arXiv:1606.04671, 2016
[6] Jaehong Yoon, Eunho Yang, Jeongtae Lee, and Sung JuHwang. Lifelong learning with dynamically expandable networks. arXiv preprint arXiv:1708.01547, 2017
[7] Arslan Chaudhry, Marc′ Aurelio Ranzato, Marcus Rohrbach, and Mohamed Elhoseiny. Efficient lifelong learning with a-gem. arXiv preprint arXiv:1812.00420, 2018
[8] David Lopez-Paz and Marc′ Aurelio Ranzato. Gradient episodic memory for continual learning. In Advances in neural information processing systems, pages 6467-6476, 2017
[9] Anthony Robins. Catastrophic forgetting, rehearsal and pseudorehearsal. Connection Science, 7(2):123-146, 1995
[10] Matthew Riemer, Ignacio Cases, Robert Ajemian, Miao Liu, Irina Rish, Yuhai Tu, and Gerald Tesauro. Learning to learn without forgetting by maximizing transfer and minimizing interference. arXiv preprint arXiv:1810.11910, 2018
[11] Sylvestre-Alvise Rebuffi, Alexander Kolesnikov, GeorgSperl, and Christoph H Lampert. icarl: Incremental classifier and representation learning. In Proceedings of the IEEE conference on Computer Vision and Pattern Recognition, pages 2001-2010, 2017
[12] Rahaf Aljundi, Min Lin, Baptiste Goujaud, and Yoshua Bengio. Gradient based sample selection for online continual learning. In Advances in Neural Information Processing Systems, pages 11816-11825, 2019
[13] Ari S Benjamin, David Rolnick, and Konrad Kording. Measuring and regularizing networks in function space. arXivpreprint arXiv:1805.08289, 2018
[14] Pietro Buzzega, Matteo Boschini, Angelo Porrello, DavideAbati, and Simone Calderara. Dark experience for general continual learning: a strong, simple baseline. arXiv preprintarXiv:2004.07211, 2020
[15] Sebastian Farquhar and Yarin Gal. Towards robust evaluations of continual learning. arXiv preprintarXiv:1805.09733, 2018
[16] Jeffrey S Vitter. Random sampling with a reservoir. ACM Transactions on Mathematical Software (TOMS), 11(1):37-57, 1985
[17] Antti Tarvainen and Harri Valpola. Mean teachers are better role models: Weight-averaged consistency targets improve semi-supervised deep learning results. arXiv preprintarXiv:1703.01780, 2017
[18] Jonathan Schwarz, Wojciech Czarnecki, Jelena Luketina, Agnieszka Grabska-Barwinska, Yee Whye Teh, Razvan Pascanu, and Raia Hadsell. Progress & compress: A scalable framework for continual learning. In International Conference on Machine Learning, pp. 4528-4537. PMLR, 2018.
[19] Arslan Chaudhry, Puneet K Dokania, Thalaiyasingam Ajanthan, and Philip H S Torr. Riemannian walk for incremental learning: Understanding forgetting and intransigence. In Proceedings of the European Conference on Computer Vision (ECCV), pp. 532-547, 2018a.
[20] Tyler L Hayes, Giri P Krishnan, Maxim Bazhenov, Hava T Siegelmann, Terrence J Sejnowski, and Christopher Kanan. Replay in deep learning: Current approaches and missing biological elements. Neural Computation, 33(11):2908-2950, 2021.
[21] Friedemann Zenke, Ben Poole, and Surya Ganguli. Continual learning through synaptic intelligence. In International Conference on Machine Learning, pp. 3987-3995. PMLR, 2017.
[22] Elahe Arani, Fahad Sarfraz, and Bahram Zonooz. Learning fast, learning slow: A general continual learning method based on complementary learning system. In International Conference on Learning Representations, 2021.
[23] Nitin Kamra, Umang Gupta, and Yan Liu. Deep generative dual memory network for continual learning. ArXiv preprint arXiv:1710.10368, 2017.
[24] Matthew P Walker and Robert Stickgold. Sleep-dependent learning and memory consolidation. Neuron, 44(1):121-133, 2004.
[25] James L McClelland, Bruce L McNaughton, and Randall C O'Reilly. Why there are complementary learning systems in the hippocampus and neocortex: insights from the successes and failures of connectionist models of learning and memory. Psychological review, 102(3):419, 1995.
[26] Demis Hassabis, Dharshan Kumaran, Christopher Summerfield, and Matthew Botvinick. Neuroscience-inspired artificial intelligence. Neuron, 95(2):245-258, 2017.
[27] Jeffrey S Vitter. Random sampling with a reservoir. ACM Transactions on Mathematical Software (TOMS), 11(1):37-57, 1985.
[28] Giri P Krishnan, Timothy Tadros, Ramyaa Ramyaa, and Maxim Bazhenov. Biologically inspired sleep algorithm for artificial neural networks. arXiv preprint arXiv:1908.02240, 2019.
[29] Roger L Redondo and Richard G M Morris. Making memories last: the synaptic tagging and capture hypothesis. Nature Reviews Neuroscience, 12(1):17-30, 2011.

1. A computer-implemented method of synaptic consolidation and dual memory experience replay for training a neural network associated with filters in convolutional layers, such as for processing an image, using a dual memory system comprising an episodic memory, and a semantic memory, wherein said method comprises the step of:
using a Fisher information matrix for estimating the importance of each synapse in the network to previous tasks of the neural network;
evaluating the Fisher information matrix on the episodic memory using the semantic memory;
adjusting the importance estimate whereby the importance of each filter is given by the mean importance of its parameters;
using weights of the semantic memory as the anchor parameters for constraining an update of the synapses of the network based on the adjusted importance estimate;
updating the aggregated fisher information matrix stochastically using exponential moving average of the fisher matrices evaluated throughout training;
updating the semantic memory stochastically using exponential moving average of the neural network weights;
interleaving samples from a current task with samples from the episodic memory for performing the training wherein the neural network is updated using stochastic gradient descent using the gradients with respect to a combined loss function over the method, such as comprising a supervised task loss, a consistency regularization loss and a synaptic consolidation loss.

2. The computer-implemented method according to claim 1, wherein the step of evaluating the aggregated Fisher information matrix comprises evaluating the Fisher Information matrix using the semantic memory on the samples in the episodic memory and aggregated using an exponential moving average to aggregate the Fisher matrix throughout the training.

3. The computer-implemented method according to claim 2, and wherein the step of adjusting the importance estimate of a filter comprises using the mean of the parameters of a filter in the aggregated Fisher information matrix.

4. The computer-implemented method according to claim 1, wherein constraining the parameters of the neural network comprises anchoring the parameters to the semantic memory weighted by the adjusted Fisher information matrix.

5. The computer-implemented method according to claim 1, wherein the method step of evaluating the Fisher information matrix is performed stochastically to the exclusion of the use of task boundaries.

6. The computer-implemented method according to claim 1, wherein the method step of updating the semantic memory comprises aggregating weights of the neural network stochastically using an exponential moving average.

7. The computer-implemented method according to claim 1, wherein the semantic memory interacts with the episodic memory to provide replay logits for adding consistency regularization to the update of the neural network.

8. The computer-implemented method according to claim 1, comprising the step of providing a data stream from a vehicle to the network via the associated filters, and wherein outputs of the neural network are used as driver responses for autonomously piloting said vehicle.

9. An at least partially autonomous driving system comprising at least one camera designed for providing a feed of images, and a computer designed for implementing the method according to claim 1, wherein the system is designed for using said feed of images for training the neural network, and wherein the network is designed for outputting driver responses for piloting the system in response to the feed of images.

10. A computer-readable storage medium comprising a program for executing the method according to claim 1 on a computer.

11. A computer-implemented simulation of autonomous driving of a vehicle on a road, the method comprising:
providing a data stream;
applying the method according to claim 1, wherein the data stream is provided to the neural network and associated filters; and
simulating a driver response to the data stream using outputs of said network.

12. The computer-implemented method according to claim 8, wherein the data stream comprises a live feed of images.

13. The computer-implemented method according to claim 9, wherein the system is designed for using said feed of images for training the neural network while driving.

14. The computer-implemented simulation of autonomous driving of a vehicle on a road according to claim 11, wherein the data stream comprises a live feed of images.

15. A computer-implemented method of synaptic consolidation and dual memory experience replay for training a neural network associated with filters in convolutional layers, such as for processing an image, using a dual memory system comprising an episodic memory, and a semantic memory, wherein said method comprises the steps of:
using a Fisher information matrix for estimating the importance of each synapse in the network to previous tasks of the neural network;
evaluating the Fisher information matrix on the episodic memory using the semantic memory, or on the semantic memory;
wherein the neural network is updated using stochastic gradient descent using the gradients with respect to a loss function over the method.

16. An apparatus, comprising a plurality of computers or distributed systems programmed to implement the method steps according to claim 15, wherein the apparatus is arranged such that processing is performed by a microprocessor, computing cloud, Application Specific Integrated Circuit (ASIC), Field Programmable Gate Array (FPGA), in conjunction with memory, network, and bus elements.

17. The apparatus according to claim 16, wherein the apparatus comprises one or more processors and/or microcontrollers which are designed to operate via instructions stored on one or more tangible non-transitive memory-storage devices comprised in the apparatus.

18. A tangible non-transitive memory-storage devices comprising instructions to implement the method according to claim 15.
